(19) United States
(12) Patent Application Publication
(10) Pub. No.: US 2004/0167857 A1
(43) Pub. Date: Aug. 26, 2004

(54) Systems and methods for prevention of peer-to-peer file sharing

(75) Inventors: Peter D. Baker, Aliso Viejo, CA (US); Karen Neal, Los Angeles, CA (US); Susan L. Baker, Aliso Viejo, CA (US)

Correspondence Address: ORRICK, HERRINGTON & SUTCLIFFE, LLP, 4 PARK PLAZA, SUITE 1600, IRVINE, CA, 92614-2558, US

(73) Assignee: NB Networks

(21) Appl. No.: 10/787,646

(22) Filed: Feb. 25, 2004

Related U.S. Application Data
(63) Continuation-in-part of application No. 10/715,954, filed on Nov. 17, 2003.
Application No. 10/715,954 is a continuation-in-part of application No. 10/272,471, filed on Oct. 15, 2002, now Pat. No. 6,651,102.
Application No. 10/272,471 is a continuation-in-part of application No. 09/898,852, filed on Jul. 3, 2001, now Pat. No. 6,493,761.
Application No. 09/898,852 is a continuation-in-part of application No. 09/113,704, filed on Jul. 10, 1998, now Pat. No. 6,266,700.
Application No. 09/113,704 is a continuation of application No. 09/080,325, filed on May 15, 1998, now Pat. No. 6,000,041.
Application No. 09/080,325 is a continuation of application No. 08/888,875, filed on Jul. 7, 1997, now Pat. No. 5,781,729.
Application No. 08/888,875 is a continuation of application No. 08/575,506, filed on Dec. 20, 1995, now Pat. No. 5,793,954.

(51) Int. Cl. H04L 9/00

(52) U.S. Cl. 705/51

(57) ABSTRACT

A secure digital content delivery system includes a content provider and a content user. The content provider delivers encrypted content to the content user in response to delivery requests. The content provider generates encryption algorithms on the fly and encrypts the content prior to delivery, optionally using a different encryption algorithm and key for each content delivery. The content user subsequently requests access permission from the content provider, to access the encrypted content. The content provider grants access by generating an executable decryption module on the fly and providing the executable decryption module to the content user. The content user decrypts the content and accesses it on the fly, using the executable decryption module. The accessed content is then re-encrypted using a different encryption algorithm and key, to preserve the integrity of the secure content delivery system. The content delivery system uses a programmably configurable protocol parsing engine to encrypt and decrypt content. The content delivery system is able to generate executable code to implement the functions of the protocol parsing engine, to streamline the processing of the content.

### PRIORITY INFORMATION

This is a continuation-in-part of application U.S. Ser. No. 10/715,954, filed on Nov. 17, 2003, which is a continuation-in-part of application U.S. Ser. No. 10/272,471, filed on Oct. 15, 2002, which issued as U.S. Pat. No. 6,651,102 on Nov. 18, 2003, which is a continuation-in-part of application U.S. Ser. No. 09/898,852, filed on Jul. 3, 2001, which issued as U.S. Pat. No. 6,493,761 on Dec. 10, 2002, which is a continuation-in-part of application U.S. Ser. No. 09/113,704, filed on Jul. 10, 1998, which issued as U.S. Pat. No. 6,266,700 on Jul. 24, 2001, which is a continuation of U.S. Ser. No. 09/080,325, filed on May 15, 1998, which issued as U.S. Pat. No. 6,000,041 on Dec. 7, 1999, which is a continuation of U.S. Ser. No. 08/888,875, filed on July 7, 1997, which issued as U.S. Pat. No. 5,781,729 on Jul. 14, 1998, which is a continuation of U.S. Ser. No. 08/575,506, filed on Dec. 20, 1995, which issued as U.S. Pat. No. 5,793,954 on Aug. 11, 1998, the disclosures of all of which are expressly incorporated herein by reference.

### COPYRIGHT NOTICE

A portion of the disclosure of this patent document contains material that is subject to copyright protection. The copyright owner has no objection to the xerographic reproduction by anyone of the patent document or the patent disclosure in exactly the form it appears in the Patent and Trademark Office patent file or records, but otherwise reserves all copyright rights whatsoever.

### FIELD OF THE INVENTION

The field of the invention relates to distribution of content over a network or stored on electronic media, and more particularly to systems and methods of protecting content from unauthorized distribution.

### BACKGROUND OF THE INVENTION

With the burgeoning growth of the Internet, there is an ever-increasing amount of content being distributed over the Internet. As technology progresses, consumers are demanding that more content be made available in digital form, to take advantage of the improved sound and visual quality provided by digital recordings. Digital content such as music, movies, software, and the like are rapidly becoming the most popular types of files being transmitted across the Internet.

Unfortunately, much of this digital content transmission is being done without the authorization of the rightful owners of the content. Since modem computer technology allows digital content to be easily and cheaply copied, with no loss in the quality of the original recording, it has become very easy to create perfect copies of digital content. Now that any personal computer, for example, can make a perfect copy of digital content, it has become very easy for people to make unauthorized copies of digital content, potentially costing the legitimate owners of the digital content millions or even billions of dollars of lost revenue.

In response to all of this unauthorized copying, the rightful owners and distributors of digital content have resorted to a variety of technological methods to prevent copying. For example, software manufacturers have tried embedding secret codes into the distribution media (e.g. CD-ROMs or floppy disks), in sectors of the distribution media that are not easily accessed by users. The software is configured to check for the existence of the secret code, and if the code is not present, the software fails to execute. Since the sectors of the distribution media are not easily accessible, the secret codes are difficult to copy. However, modem copying techniques are able to defeat this scheme by making an exact duplicate of the entire CD-ROM or floppy disk, including the secret codes. Also, this scheme can frustrate end users who wish to make legitimate copies of the software, for example for backup purposes.

Various forms of encryption have also been tried, wherein the digital content is stored in an encrypted format, with a variety of hardware or software systems being installed on the end-user's equipment, to decrypt and play the content. For example, manufacturers have tried to install decryption chips into consumer electronics such as videocassette recorders/players, CD players, DVD players, etc. Alternatively, on computerized content playback systems, the decryption routines are provided as computer software, for example in a .DLL (dynamic link library) or other code file installed on the playback system when the system is manufactured. This code file is accessed by the computer application that is seeking to decrypt the encrypted content, and once the content is decrypted, it is then played, or copied.

These decryption systems, however all suffer from a significant drawback. Since the code that is used to implement the decryption routines is installed onto the end user's device, either as a hardware component (such as on a VCR or DVD player) or as a software module (such as on a computer), this code is fairly easily accessible to the end user. Those seeking to defeat the encryption scheme can therefore more easily reverse-engineer the encryption algorithm, and more easily break the encryption system. Furthermore, once the encryption algorithm is broken, then all content encrypted with the algorithm can then be made accessible merely by distributing a single decoder program. Since most content providers only distribute a single encryption algorithm with their various content, once this algorithm is broken, all of the content is unprotected. Since the decryption routines are installed on the end user's device, the routines are difficult to change, should the content provider wish to implement a different encryption/decryption algorithm. Thus, there is a need for an improved system of preventing unauthorized copying of digital content, while still facilitating legitimate use and copying of the digital content.

### SUMMARY OF THE INVENTION

In an aspect of an embodiment of the invention, an encryption or decryption algorithm is generated on demand by a content provider.

In another aspect of an embodiment of the invention, an encryption or decryption algorithm is provided on demand to a content user.

In another aspect of an embodiment of the invention, an encryption or decryption algorithm is requested by a content user every time the content user wishes to access the encrypted content.

In another aspect of an embodiment of the invention, an encryption or decryption algorithm is automatically generated on demand by the content provider, using protocol descriptions.

In another aspect of an embodiment of the invention, the decrypted content is re-encrypted after being accessed, using a different encryption algorithm than the decrypted content was originally encrypted in.

In another aspect of an embodiment of the invention, encryption and decryption algorithms are represented as data modification operations within programmably configurable protocol descriptions.

In another aspect of an embodiment of the invention, the decryption and encryption algorithms are stored in volatile memory on the end user's device, and are erased and deleted after use.

In another aspect of an embodiment of the invention, computer executable code is automatically generated by using programmably configurable protocol descriptions and data modification operations to configure a protocol parsing engine.

### BRIEF DESCRIPTION OF THE DRAWINGS

In order to better appreciate how the above-recited and other advantages and objects of the present inventions are obtained, a more particular description of the invention briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 depicts a system for securely distributing digital content, in accordance with an embodiment of the invention.

FIG. 2 depicts a content provider of an embodiment of the invention.

FIG. 3 depicts a content user of an embodiment of the invention.

FIG. 4 depicts a computer within a content provider of an embodiment of the invention.

FIG. 5 depicts a media reader within a content user of an embodiment of the invention.

FIG. 6 is a flowchart of a method of operating a content provider to respond to a purchase request from a content user.

FIG. 7 is a flowchart of a method of operating a content user to purchase content.

FIG. 8 is a flowchart of a method of operating a content provider to allow encrypted content to be played by a content user.

FIG. 9 is a flowchart of a method of operating a content user to play encrypted content.

FIG. 10 is a flowchart of a method of operating a content provider to allow an encrypted content item to be copied by a content user.

FIG. 11 is a flowchart of an alternate method of operating a content provider to allow an encrypted content item to be copied by a content user.

FIG. 12 is a flowchart of a method of operating a content user to copy an encrypted content item.

FIG. 13 is a flowchart of an alternate method of operating a content user to obtain a copy of a content item.

### DETAILED DESCRIPTION OF THE PREFERRED EMBODIMENTS

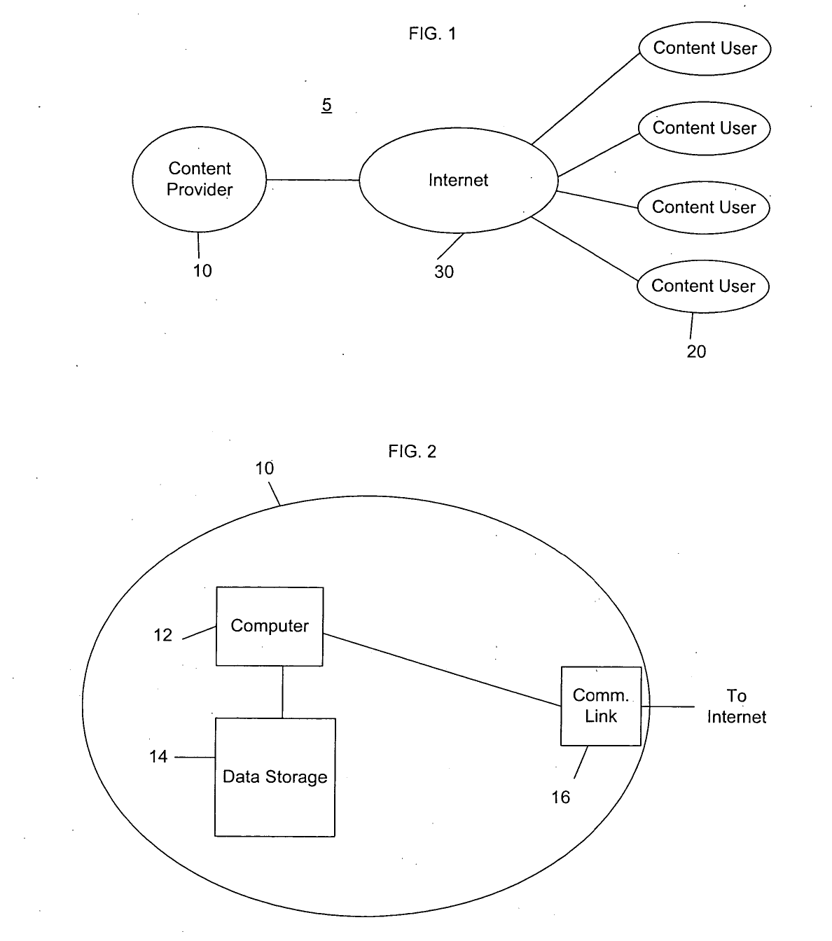

Turning to FIG. 1, in accordance with an embodiment, a system 5 for securely distributing digital content includes a content provider 10, one or more content users 20, and a network 30. The content provider 10 may be any provider of digital content who wishes to keep that content secure. For example, the content provider 10 may be an audio or recording company, a movie distribution company, a computer software company, a video rental company, or the like. The content provider 10 may also be a computer or other similar electronic device or collection of devices operated by any of the above enumerated entities. The content user 20 may be any user of digital content, including both natural persons and electronic devices, either being operated by natural persons or operating independently. The network 30 may be any means of establishing communications between the content provider 10 and the content user 20, for the purpose of transferring content between the content provider 10 and the content user 20. For example, the network 30 may be a series of linked computers such as the Internet. Alternatively, the network 30 may be a direct connection between the content provider 10 and the content user 20, such as a wired telephone connection or a wireless link. Alternatively, the content provider 10 and the content user 20 may both reside on the same computer, and the network 30 may be a data path within that computer between the content provider 1 0 and the content user 20.

Turning to FIG. 2, the content provider 10 of an embodiment includes a computer 12, data storage 14, and a communications link 16. The computer 12 may be any type of device that is capable of receiving and processing requests to access digital content. For example, the computer 12 may be a personal computer, a network of personal computers, a server in a client/server model, a mainframe computer, etc. The data storage 14 may be any form of volatile or non-volatile storage medium that is capable of storing digital data. For example, the data storage 14 may be a hard disk, a RAM memory, a RAID array, a WORM drive, an optical disk, a floppy disk, etc. The communications link 16 may be any type of communication device that allows digital data to be transferred into and out of the content provider 10. For example, the communications link 16 may be a network interface card such as an Ethernet card installed in the computer 12, a telephone coupling such as a modem, a wireless radio or cellular telephone coupling, a pager network coupling, a fibre optic channel, etc.

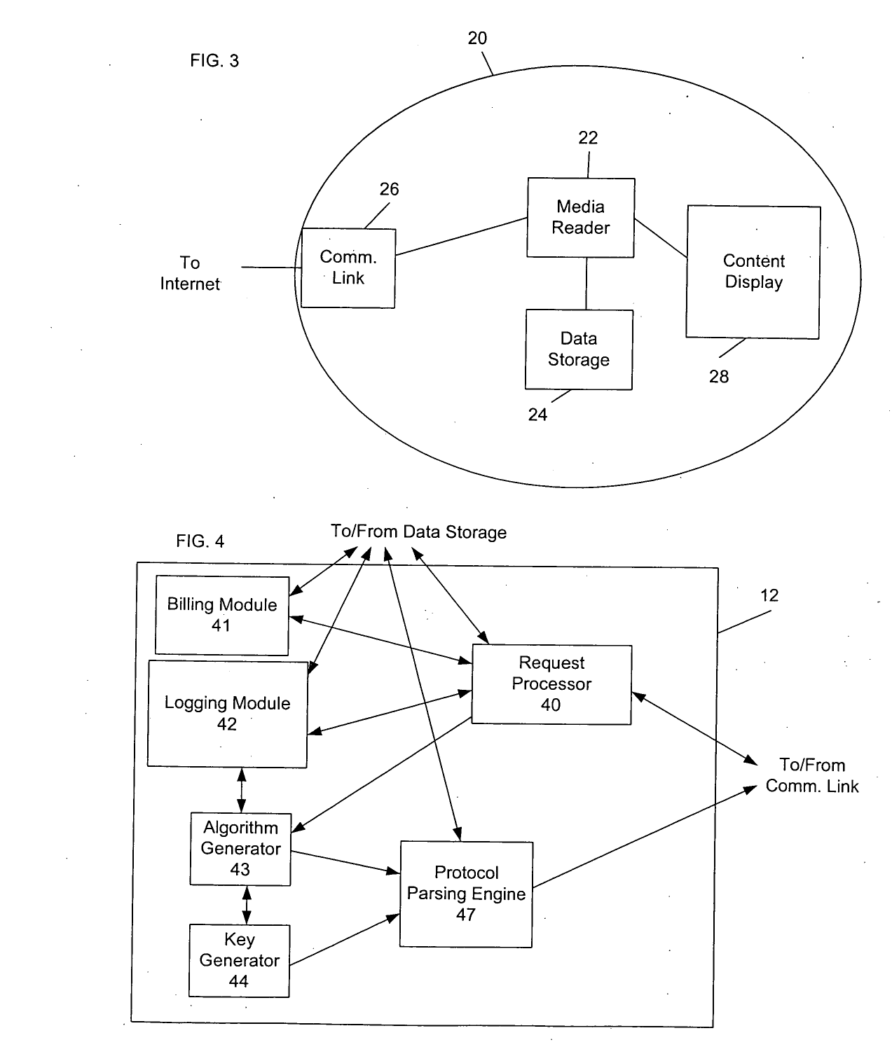

Turning to FIG. 3, the content user 20 of an embodiment includes a media reader 22, a data storage 24, a communications link 26, and a content display 28. The media reader 22 may be any device capable of processing and reading digital media. For example, the media reader 22 may be a personal computer, an MP3 player, a CD player, a DVD player, etc. The data storage 24 may be any form of volatile or non-volatile storage medium that is capable of storing digital data. For example, the data storage 24 may be a hard disk, a RAM memory, a RAID array, a WORM drive, an optical disk, a floppy disk, etc. The communications link 16 may be any type of communication device that allows digital data to be transferred into and out of the content user 20. For example, the communications link 26 may be a network interface card such as an Ethernet card installed in the media reader 22, a telephone coupling such as a modem, a wireless radio or cellular telephone coupling, a pager network coupling, a fibre optic channel coupling, etc. The content display 28 may be any device capable of receiving digital content and displaying it, either in digital or analog or some other format. For example, the content display 28 may be an audio speaker or speaker system, a video monitor, a television set, etc.

Turning to FIG. 4, the computer 12 includes several modules. These modules may be implemented in either software, hardware, firmware, or some combination of software, hardware and firmware. The modules in the computer 12 include a request processor 40, billing module 41, a logging module 42, an algorithm generator 43, a key generator 44 and a protocol parsing engine 47. The modules of computer 12 may also be distributed among multiple computers 12, as desired for more efficient operations. The modules may also be combined together. For example, the key generator 44 may be combined with the algorithm generator 43, or both of these modules may be combined with the protocol parsing engine 47.

The request processor 40 receives requests from the content users 20, manages the flow of data between the other modules of the computer 12, and causes outgoing messages and content to be sent to the content users 20. The billing module 41 receives billing information from the content users 20 and interfaces with financial services providers such as banks, credit card companies, etc., in order to ensure that content users 20 have made any necessary payments in order to access the digital content being protected by the system 5. The logging module 42 receives logging requests from the request processor 40, and logs the requests and any other desired information, such as keys or algorithms used to protect content, the status of any request, historical information about the content users 20, and the like, into the data storage 14.

The algorithm generator 43, key generator 44 and protocol parsing engine 47 work in combination to provide the desired security to protect the digital content being managed by the content provider 10. Many of the elements of and principles behind these modules are discussed in full detail in U.S. Pat. No. 6,651,102, which reference is hereby incorporated herein by reference, in its entirety. Further elements and principles behind these modules are discussed in full detail in U.S. Pat. No. 6,493,761, U.S. Pat. No. 6,266,700, U.S. Pat. No. 6,000,041, U.S. Pat. No. 5,781,729, and U.S. Pat. No. 5,793,954, all of which are hereby incorporated herein by reference, in their entirety.

Briefly summarizing the operation of these modules, the algorithm generator 43 generates encryption algorithms, either as a stand-alone process, or with the assistance of an administrator. For example, the algorithm generator 43 may be a user interface, under the control of an administrator, used by the administrator to create the algorithm. Such a user interface might, in one embodiment, allow the administrator or other user to select the operations used in the algorithm. Alternatively, the algorithm generator 43 may be an interface within a software integrated development environment, that allowed a developer to specify library calls for the various operations used in the algorithm. Alternatively, the algorithm generator 43 may be an automated computer program that retrieves algorithms from a pre-generated library of algorithms, or that generates algorithms automatically according to a user-supplied algorithm policy.

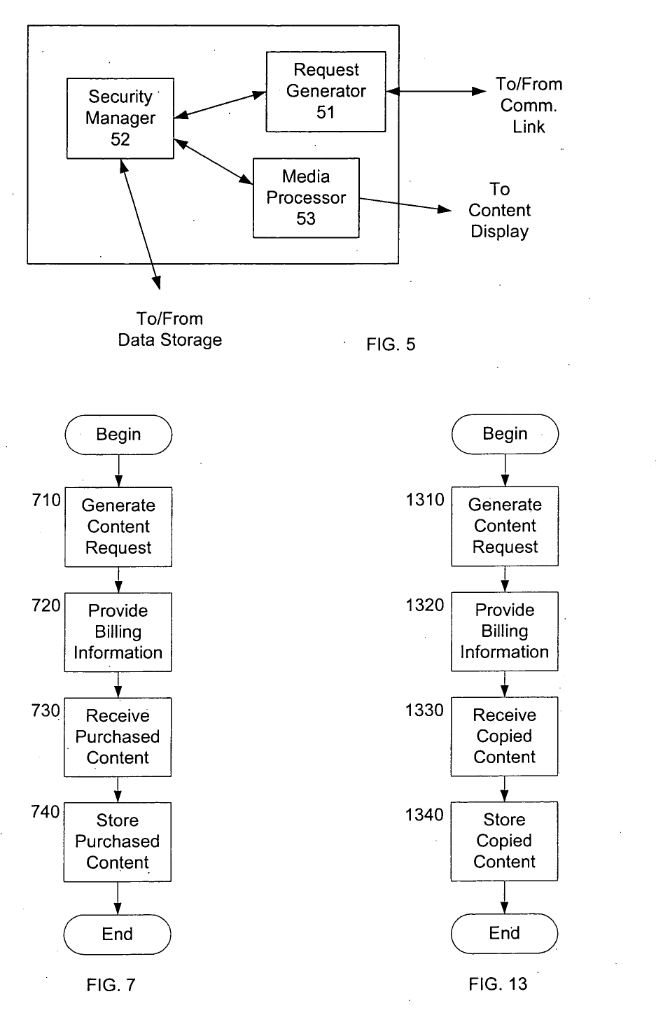

Examples of the encryption algorithms which may be generated by the algorithm generator 43 are the encryption algorithms discussed in U.S. Pat. No. 6,651,102 (for example at FIGS. 5-7). Content providers may already have implemented encryption policies or encryption schemes which specify the general parameters for the encryptions to be applied to their data, such as number of transformations, type of transformations, as well as specific algorithms which the content provider prefers. All of this provider-specific customization may be represented in the algorithms generated by the algorithm generator 43, merely by modifying the number of or ordering of the steps of the algorithm, or the values used in the steps of the algorithm, as well as by changing the actual types of modifications to be used in the algorithm. Once an algorithm or scheme has been formulated, then the algorithm generator 43 may be automated, by, for example, instructing the algorithm generator 43 to select the values used in the steps of the algorithm at random, or to re-order the steps of the algorithm according to some configured policy. These algorithms are then expressed as encryption/decryption operations within protocol descriptions, to be provided to the protocol parsing engine 47.

The key generator 44 generates keys to be used with the algorithms generated by the algorithm generator 43. For example, the key generator 44 may be an interface or external policy or device used by an administrator to create the key. Alternatively, the key generator 44 may be an automated computer program that retrieves keys from a key library, or that generates keys automatically, according to a user-supplied key policy.

These keys may, for example, be used as described in U.S. Pat. No. 6,651,102, along with the algorithms described in that patent, to encrypt or decrypt data. The keys may be generated according to the content provider's key generation policy, which may specify, for example, key sizes, key lengths or data widths, or other requirements such as requiring certain characters in the key, or forbidding certain characters. These keys may be modified using operations within a protocol description, or they may be used by or incorporated into the algorithms generated by the algorithm generator 43. The key generator 44 may be a separate module, or the key generator 44 may be incorporated into the algorithm generator 43.

The protocol parsing engine 47 is configured to perform various protocol parsing functions, using one or more programmably configurable protocol descriptions. For example, the protocol parsing engine 47 may be configured to perform data modifications such as encrypting and decrypting data, as discussed in U.S. Pat. No. 6,651,102. Alternatively, the protocol parsing engine 47 may be configured to gather statistics, perform routing functions, or modify text formats, as discussed in the various other US Patent references incorporated by reference. The protocol parsing engine 47 may be configured to perform any number of different protocol parsing functions, including combinations of more than one protocol parsing function.

The protocol parsing engine 47 uses these programmably configurable protocol descriptions, along with common control logic, to perform the various operations specified by the protocol descriptions. This allows the protocol parsing engine 47 to be re-configured entirely through user input, without the need for hardware or software system modifications. Thus, those skilled in the art with the benefit of this disclosure and the disclosures of the US patents incorporated by reference will appreciate that the system 5 in accordance with an embodiment of the invention may be configured and reconfigured in a highly efficient and cost-effective manner to implement numerous different operations or combinations of operations, and to accommodate substantial application or task modifications, such as the use of different types of data processors, different encryption schemes, different encryption algorithms and keys, different key lengths, etc., without requiring substantial system changes. Additionally, embodiments of the system 5 provide the ability for the user to change everything about any defined encryption/decryption algorithm that can be changed. For example, the user can change the size, number, and data width of any required P and S boxes. The number of iterations, the width of the operation, the size and data width of the key, as well as the location of any variables and P/S boxes in memory can be configured by the user. It is even possible to implement the same algorithm using many different operation sequences.

The protocol parsing engine 47 retrieves input data from any source of digital data, such as an input data file or a streaming data source such as a network data transmission stream. The protocol parsing engine 47 then parses this data, according to the programmably configurable protocol description which was used to configure the protocol parsing engine 47. For example, if the protocol parsing engine 47 is configured with a protocol description that includes a data modification operation, then the protocol parsing engine 47 will parse the input data and modify the input data according to the data modification operation. Thus if the data modification operation is an encryption operation, the protocol parsing engine 47 will encrypt the data. Similarly, if the data modification operation is a decryption operation, then the protocol parsing engine 47 will decrypt the data. If the protocol parsing engine 47 is configured with a protocol description that includes a data filtering operation, then the protocol parsing engine 47 will parse the input data and filter the input data according to the data filtering operation. If the protocol parsing engine 47 is configured with a programmably configurable protocol description that includes specifications of routines which generate executable code for performing some or all of the configured operations, then the protocol parsing engine 47 will parse the input data using the executable code generated by the protocol parsing engine 47 when it was configured with the protocol description.

If the protocol parsing engine 47 is configured with a protocol description that includes multiple different operations, such as a filtering operation and a statistics gathering operation and a next-protocol determining operation, then the protocol parsing engine will parse the data according to all of the configured operations. For example, the protocol parsing engine 47 would first filter the input data according to the filtering operation, to extract the desired data. Then the protocol parsing engine 47 would compile any configured statistics for the input data. Finally the protocol parsing engine 47 would determine the next protocol description to invoke, for further processing of the input data.

When generating encryption or decryption code, for example, the protocol parsing engine 47 takes the protocol description containing the specifications of the code generation routines for the algorithm and key generated by the algorithm generator 43 and key generator 44, and uses these routines to generate executable code for the encryption or decryption process. The protocol parsing engine 47 may generate code as part of the process of configuring the protocol parsing engine 47 to encrypt or decrypt digital content. This code is used to streamline the encryption or decryption of digital content at the content provider 10. Alternatively, the protocol parsing engine 47 may generate code to be provided to the security manager 52 on the content user 20, so the security manager 52 may encrypt or decrypt digital content. In this alternate mode, the generated code is supplied to the communications link 16, for provision to the security manager 52 on the content user 20, where the digital content is encrypted or decrypted.

The protocol description for the algorithm and/or key includes, for example, specifications of routines that create executable code that when executed will encrypt or decrypt a data file, as well as routines that will set up the various components of the encryption/decryption algorithm, such as the S-Boxes and P-Boxes discussed in U.S. Pat. No. 6,651,102. For example, the protocol description specifies an executable code routine for each of the data manipulation operations, or setup operations, that are specified in a data manipulation operations within a protocol description, such as the data manipulation operations of FIGS. 5-7 of U.S. Pat. No. 6,651,102. When the protocol description including the specification of the code generation routines is used to configure the protocol parsing engine 47, the protocol parsing engine generates code that when executed will modify the data in the content file according to the data modification operation in the protocol description.

Turning to FIG. 5, the media reader 22 includes several modules. These modules may be implemented in either software, hardware, firmware, or some combination of software hardware and firmware. The modules in the media reader 22 include a request generator 51, a security manager 52, and a media processor 53.

The request generator 5 1 is responsible for making requests to the content provider 10 for access to content. The request generator 51 may be implemented in a variety of different manners, depending upon the nature of the media reader 22. For example, if the media reader 22 is a personal computer, the request generator 51 may be a web browser. If the media reader 22 is a portable media player the request generator 51 may be a code routine installed in the firmware of the media player, which responds to a user's activation of a Play button or other such feature of the portable media player. The request generator 51 may be activated by a user of the media reader 22, or the request generator 51 may be activated by other internal processes running on the media reader 22. The request generator 51 sends information to the content provider 10 such as information specifying the identity of the media reader 22, billing information for any charges that the content provider 10 may require, or information about the particular content requested by the media reader 22.

The security manager 52 is responsible for receiving content from the content provider 10. The security manager 52 also manages decrypting encrypted content, and encrypting decrypted content as needed to provide protection to the content from the content provider 10 while allowing the content user 20 to use the content. The security manager 52 receives encrypted content from the content provider 10. The security manager 52 also receives executable encryption and decryption modules from the content provider 10, and executes those modules on decrypted or encrypted content. To further preserve the security of the content provided by the content provider 10, the security manager 52 erases and deletes the executable encryption and decryption modules once those modules have finished operations. Erasing and deleting these modules prevents them from being accessed by malicious users of the media reader 22.

The media processor 53 is responsible for processing the decrypted media files created by the security manager 52, and sending the appropriate signals to the content display 28, to display the content. The media processor may include, for example, a digital/analog converter, as well as any other circuitry useful in playing video or audio signal data.

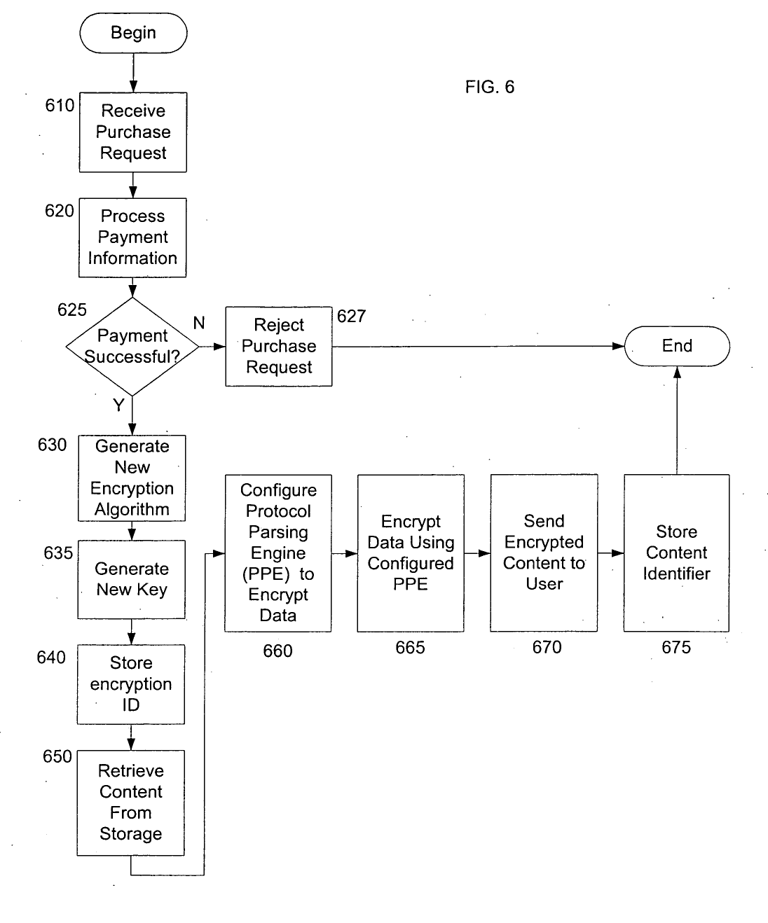

Turning to FIGS. 6-13, the system 5 for securely distributing digital content is used according to various methods, depending on the particular function being performed. Among the functions the system 5 is capable of performing are customer purchases of digital content, customer playing of digital content, and customer copying of digital content. All of these functions are performed while maintaining the security of the digital content from unauthorized copying or playing.

A method of operating a content provider 10 to respond to a purchase request from a content user 20 is shown in FIG. 6. The method begins at step 610 when the content provider 10 receives a purchase request from the content user 20. The purchase request is received over the communications link 16, from the network 30. The purchase request is routed from the communications link 16 to the request processor 40 in the computer 12. At step 620, the request processor 40 routes the request to the billing module 41 to process the content user's payment information. At step 625, if the content user's payment information is not successfully processed and payment is not made, then at step 627 the billing module 41 rejects the purchase request and the request processor 40 advises the content user 20 that the purchase request has been rejected. The rejected purchase request is also sent to the logging module 42 to record the rejected request in the content provider's logs. This information may be useful if the content provider 10 wishes to investigate the logs for patterns of potentially fraudulent conduct, or for other reasons the content provider 10 wishes to learn about the history of requests made to the content provider 10.

If the payment is successfully processed, the request processor 40 routes the purchase request onward through the modules of the computer 12 at the content provider 10. At step 630, in response to the successful purchase request, the algorithm generator 43 generates a new encryption algorithm. As discussed above, this encryption algorithm may be based upon any security policies or schemes the content provider 10 desires to use, depending on the level of security the content provider 10 wishes to implement. In an embodiment, every new purchase request triggers the creation of a new encryption algorithm to be assigned to the specific content being purchased. The corresponding decryption algorithm may also be generated at this time, if necessary. Alternatively, for many encryption/decryption schemes, the decryption algorithm is easily derived from the encryption algorithm, for example by running the steps of the encryption algorithm in reverse order. For some algorithms, running the steps of the encryption algorithm again, on encrypted content, results in decryption of the content.

Once the encryption algorithm is generated by the algorithm generator 43, then at step 635 a key for the generated algorithm is created by the key generator 44. As noted above, the key generator 44 may be a separate module from the algorithm generator 43, or it may be incorporated into the algorithm generator 43. In an embodiment, every new purchase request triggers the creation of a new encryption key to be assigned to the specific content being purchased. Alternatively, content provider 10 may develop a pool of keys and select one or more keys from this pool for use with the newly purchased content. As a further alternative, an encryption algorithm may be re-used by multiple purchasers of content, with each purchaser being assigned a different key. These alternative solutions trade off some loss in security for a simpler operation of the system.

Either or both of the encryption algorithm and the key may be selected, at least in part, based on information provided by the content user 20. For example, the customer's name, address, credit card number, or a user-selected ID number may be used to partially or filly select the algorithm and key to be used. Alternatively, an algorithm and key may be selected without using any information from the content user 20, and instead the algorithm and key are selected using some internal policies, or random selection.

Once the encryption algorithm and encryption key have been generated, then at step 640 the logging module 42 stores an encryption ID in the data storage 14 at the content provider 10. The encryption ID may comprise the actual algorithm and key themselves, or the encryption ID may comprise some other information sufficient to identify which specific algorithm and key was generated for the newly purchased content. For example, if the algorithm and key are randomly generated, then the encryption ID may be the randomly generated number that was used to select the algorithm and key.

At step 650, the request processor 40 retrieves the newly purchased content from the data storage 14, or from any other data storage where the newly purchased content may be stored, and hands the content off to the protocol parsing engine 47. At step 660, the protocol parsing engine 47 receives the encryption algorithm and encryption key generated above for the newly purchased content, for example by receiving a protocol description containing the encryption algorithm and/or the encryption key, thereby configuring the protocol parsing engine 47 to encrypt input data according to the encryption algorithm and encryption key provided. Additionally, the protocol parsing engine 47 generates executable code modules for any operations specified in the protocol descriptions containing the algorithm and key generated above that have code generation routines specified for them. At step 665, the newly purchased content is provided to the protocol parsing engine 47 as input data, and the newly purchased content is encrypted by the protocol parsing engine 47. The protocol parsing engine 47 uses the executable code modules to streamline the encryption process. Once the content is encrypted, then at step 670 the encrypted content is then sent to the content user 20, along with an identifier identifying the encrypted content. This identifier may be the encryption ID discussed above, if that encryption ID cannot be reverse-engineered or otherwise inspected to extract the encryption algorithm or key. Alternatively the identifier may be some other sequence of data that identifies the specific copy of the content being sent to the content user 20. This identifier is also stored in the data storage 14 by the logging module 42, at step 675.

Since the encryption algorithm and key are both generated on the fly and provided to the configurable protocol parsing engine 47, those skilled in the art will appreciate that the algorithm, the key, and the key length, as well as many other features or properties of the algorithm and key, can all be changed each and every time that a content user 20 purchases new content. This allows each copy of each content item sold by the content provider 10 to be, for example, encrypted not only with a unique key, but with a unique encryption algorithm, including algorithms with different key lengths.

A method of operating a content user 20 to purchase content is shown in FIG. 7. The method begins at step 710, where the request generator 51 at the content user 20 generates a request to purchase content. For example, where the request generator 51 is a web browser, the content user 20 enters information such as the title, author, or publisher of desired content. The content user 20 may conduct other activities such as searches for desired content, or reading reviews of content, in addition to requesting the content. Once the content user 20 locates the desired content and is ready to purchase it, then at step 720 the content user 20 provides billing information, such as a credit card number, to the request generator 51. The request generator 51 then forwards all of this information on to the content provider 10, via the communications link 26 and on to the network 30. At step 730 the content user 20 receives the purchased content, in encrypted form as discussed above, from the content provider 10. The encrypted content is stored in the data storage 24, at step 740, where it is made available for future requests to play or copy the content, as will be discussed in detail below.

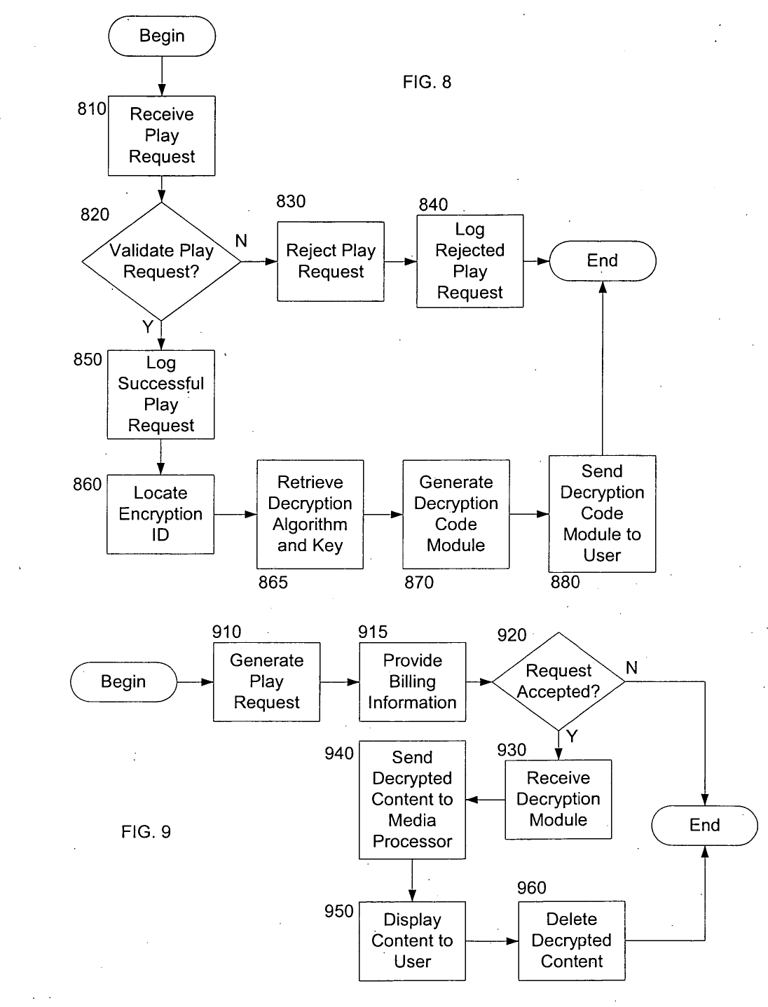

A method of operating a content provider 10 to allow encrypted content to be played by a content user 20 is shown in FIG. 8. The method begins at step 810 when the content provider 10 receives a request to play encrypted content from a content user 20, via the network 30 and communications link 16. The request processor 40 receives the play request, and validates the request at step 820. The request is validated by, for example, comparing an identifier provided by the content user 20 with the corresponding identifier created when the encrypted content was initially purchased by the content user 20. This corresponding identifier is stored at the content provider 10, as discussed at step 675 of FIG. 6. If there is a charge for playing previously purchased content, then a billing procedure similar to that discussed at steps 620-625 of FIG. 6 is followed as part of the validation step. If the content provider 10 cannot validate the play request, then at step 830, the play request is rejected, and the rejection is conveyed back to the content user 20. At step 840, the rejected request is sent to the logging module 42, for logging in the data storage 14. This allows the content provider 10 to keep track of the history of play requests, should the content provider 10 wish to investigate possible fraud attempts or other such issues.

If the validation request is successful, then at step 850, the play request, or the identifier in the play request, is sent to the logging module 42 for logging in the data storage 14. Once the play request is validated, then at step 860 the logging module 42 looks up the encryption ID for the encrypted content that is the subject of the play request, in the data storage 14. The encryption ID is used, at step 865, to retrieve the corresponding decryption algorithm and key for the encrypted content, to allow the encrypted content to be decrypted. The algorithm and key may be retrieved in a variety of ways. For example, if the encryption ID itself contains the decryption algorithm and key, then the algorithm and key are retrieved from the encryption ID itself. If the decryption algorithm and key are stored elsewhere in the data storage 14, indexed by the encryption ID, then the encryption ID is used to locate the decryption algorithm and key stored in the data storage 14.

Alternatively, in embodiments where the encryption ID is a seed value for a random selection routine that can be used to generate the decryption algorithm and key, then the decryption algorithm and key are retrieved by providing the encryption ID as a seed to the random selection routine, which results in the decryption algorithm and key being re-generated on demand. Depending on the particular encryption/decryption scheme implemented by the content provider 10, the same seed value may generate both an encryption algorithm and key, as well as the corresponding decryption algorithm and key. Since the seed value is the same as the original seed value used to create the decryption algorithm and key initially, the re-generated decryption algorithm and key will be identical to the previously created decryption algorithm and key. This alternative embodiment realizes a savings in storage space needed to store all of the algorithms and keys, at the possible tradeoff of increased response time to regenerate algorithms and keys. Note, however, that as the library of generated algorithms and keys becomes larger, regenerating algorithms and keys may eventually be faster than searching for them in the library of generated algorithms and keys.

Once the proper decryption algorithm and key for the content to be played have been recovered, then at step 870 the protocol description containing the decryption algorithm and key is passed on to the protocol parsing engine 47. The protocol parsing engine 47 uses the code generation routines specified in the protocol description to generate an executable code module to allow the security manager 52 on the content user 20 to decrypt the encrypted digital content. Details of the code generation process are discussed below. The protocol parsing engine 47 can generate code specific to the architecture of the particular media reader 22 at the content user 20, if the play request (or the prior purchase request) contained information sufficient to identify the architecture. For example, if the play or purchase request indicates that the media reader 22 is a Windows/DOS personal computer, then the protocol parsing engine 47 generates an executable code module for the Windows/DOS architecture. If the play/purchase request indicates that the media reader 22 is an Apple Macintosh personal computer, then the protocol parsing engine 47 generates an executable code module for the Macintosh architecture. Similarly, if the play/purchase request indicates that the media reader 22 is an iPod device, or a CD player, or an MP3 player, the protocol parsing engine 47 generates the appropriate executable code module.

The executable code module is only capable of decrypting content that uses the exact decryption algorithm and key provided to the protocol parsing engine 47. Therefore the executable code module cannot be used by malicious content users 20 as a universal decoder, as long as the content provider 10 has encrypted its content using a variety of different algorithms, as discussed above. In embodiments where every content item sent out from the content provider 10 is encrypted with a different algorithm and key, the executable code module can only be used on the specific content item for which it is intended. Once the executable code module is created by the protocol parsing engine 47, then at step 880 the executable code module is sent to the content user 20, via the communications link 16 and network 30.

A method of operating a content user 20 to play encrypted content is shown in FIG. 9. The method begins at step 910, where the request generator 51 at the content user 20 generates a request to play content stored in encrypted form on the content user 20. For example, where the request generator 51 is a web browser, the content user 20 enters information such as the identifier associated with the encrypted content, which was previously provided to the content user 20 when the content user 20 purchased the content item. If there is a charge associated with playing the content item, then at step 915 the content user 20 provides billing information, such as a credit card number, to the request generator 51. The request generator 51 then forwards all of this information on to the content provider 10, via the communications link 26 and on to the network 30.

At step 920, the content user 20 receives a response back from the content provider 10. The request is either denied, if the content provider 10 was unable to validate the request (or process payment if any was required), or the request is accepted and an executable decryption code module is returned to the content user 20. Assuming that the executable decryption code module is returned to the content user 20, the module is provided to the security manager 52, at step 930. In an embodiment, the executable decryption code module is stored in volatile memory on the media reader 22 at the content user 20. Limiting the executable decryption code module to volatile storage helps enhance the security of the system 5, since it is much more difficult for malicious content users 20 to obtain a copy of the executable decryption code module, to possibly inspect or reverse-engineer. The security manager 52 then retrieves the encrypted content item from the data storage 24, or other location where the encrypted content item is stored. Finally, the security manager 52 uses the encrypted content item as input data to the executable decryption code module, and creates a decrypted version of the content item. This decrypted version of the content item is also preferably stored in volatile storage, to minimize the potential for malicious content users 20 to obtain a copy of the decrypted content item. If the content item is too large to be easily stored in volatile memory, then the content item can be decrypted in pieces, each piece being stored in volatile memory until the piece is processed, and then the piece is erased and deleted and replaced with a successive piece of the decrypted content item.

Once the security manager 52 decrypts, or begins decrypting, the content item to be played, at step 940 the decrypted portion of the content item is provided to the media processor 53 for processing. The media processor 53 processes the decrypted content item and routes the output to the content display 28 at step 950, where the content is enjoyed by the content user 20 or others. Once the content item is finished being displayed, or for streaming content items such as audio files, once a portion of the content item stream is finished being displayed, then at step 960 the decrypted content item or portion thereof is erased and deleted from the media reader 22, thereby preserving security of the content item and maintaining the integrity of the system 5.

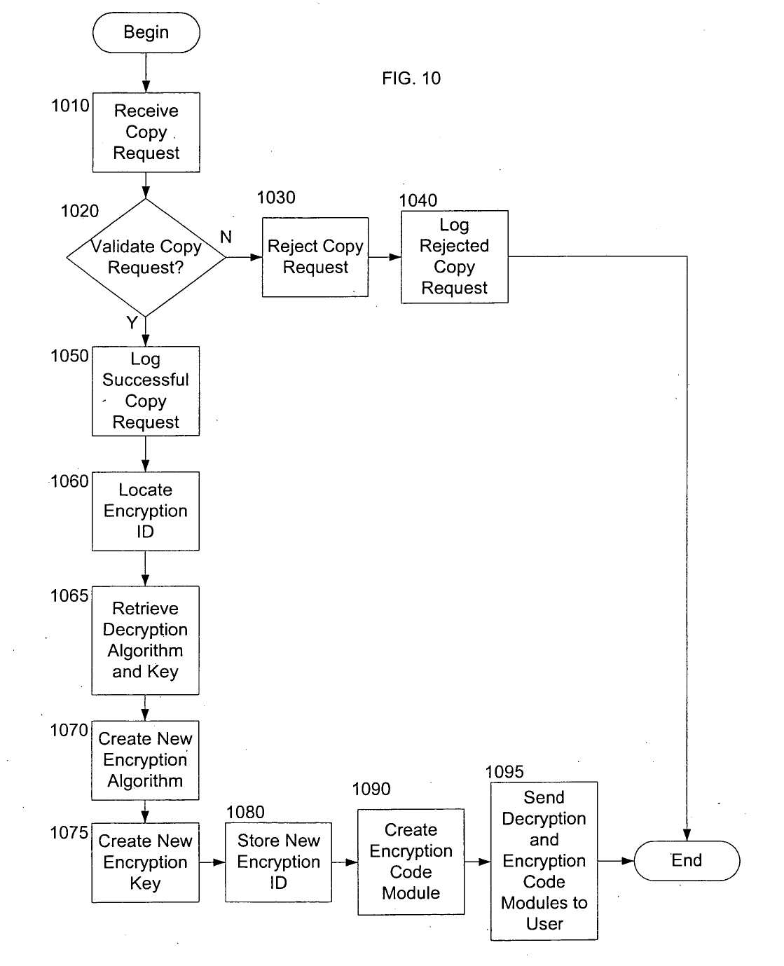

A method of operating a content provider 10 to allow an encrypted content item to be copied by a content user 20 is shown in FIG. 10. The method begins at step 1010 when the content provider 10 receives a request to copy encrypted content from a content user 20, via the network 30 and communications link 16. The request processor 40 receives the copy request, and validates the request at step 1020. The request is validated by, for example, comparing an identifier provided by the content user 20 with the corresponding identifier created when the encrypted content was initially purchased by the content user 20. This corresponding identifier is stored at the content provider 10, as discussed at step 675 of FIG. 6. If there is a charge for copying previously purchased content, then a billing procedure similar to that discussed at steps 620-625 of FIG. 6 is followed as part of the validation step. If the content provider 10 cannot validate the copy request, then at step 1030, the copy request is rejected, and the rejection is conveyed back to the content user 20. At step 1040, the rejected request is sent to the logging module 42, for logging in the data storage 14. This allows the content provider 10 to keep track of the history of copy requests, should the content provider 10 wish to investigate possible fraud attempts or other such issues.

If the validation request is successful, then at step 1050, the copy request, or the identifier in the copy request, is sent to the logging module 42 for logging in the data storage 14. Once the copy request is validated, then at step 1060 the logging module 42 looks up the encryption ID for the encrypted content that is the subject of the copy request, in the data storage 14. The encryption ID is used, at step 1065, to retrieve the corresponding decryption algorithm and key for the encrypted content, to allow the encrypted content to be decrypted. The algorithm and key may be retrieved in a variety of ways, as discussed above for retrieving algorithms and keys for play requests.

Once the decryption algorithm and key are retrieved, then at step 1070, in response to the validated copy request, the algorithm generator 43 generates a new encryption algorithm to be used to encrypt the copy, once it is made. The algorithm generator 43 performs this step in a manner similar to generating new encryption algorithms for newly purchased content, as discussed for step 630 of FIG. 6. Once the encryption algorithm is generated by the algorithm generator 43, then at step 1075 a key for the generated algorithm is created by the key generator 44. The key generation step proceeds similarly to that at step 635 of FIG. 6 above. Once the encryption algorithm and encryption key have been generated, then at step 1080 the logging module 42 stores a new encryption ID in the data storage 14 at the content provider 10 for the new copy. This step is performed in a manner similar to step 640 of FIG. 6 above. 711 Once the proper decryption algorithm and key for the content to be copied have been recovered, and the new encryption algorithm and key for the new copy have been created, then at step 1090 a protocol description containing the decryption algorithm and key are passed on to the protocol parsing engine 47. The protocol parsing engine 47 generates an executable code module to configure the security manager 52 at the content user 20 to decrypt the encrypted content item to be copied. This process is performed in a manner similar to step 870 of FIG. 8 above. The protocol parsing engine 47 then generates an executable code module to configure the security manager 52 at the content user 20 to encrypt the new copy of the content item that is about to be created. This process is performed in a manner similar to step 870 of FIG. 8 above, except that the executable encryption code module will encrypt rather than decrypt the content item provided as input. Once the two executable code modules are created by the protocol parsing engine 47, then at step 1095, the executable code modules are sent to the content user 20, via the communications link 16 and network 30.

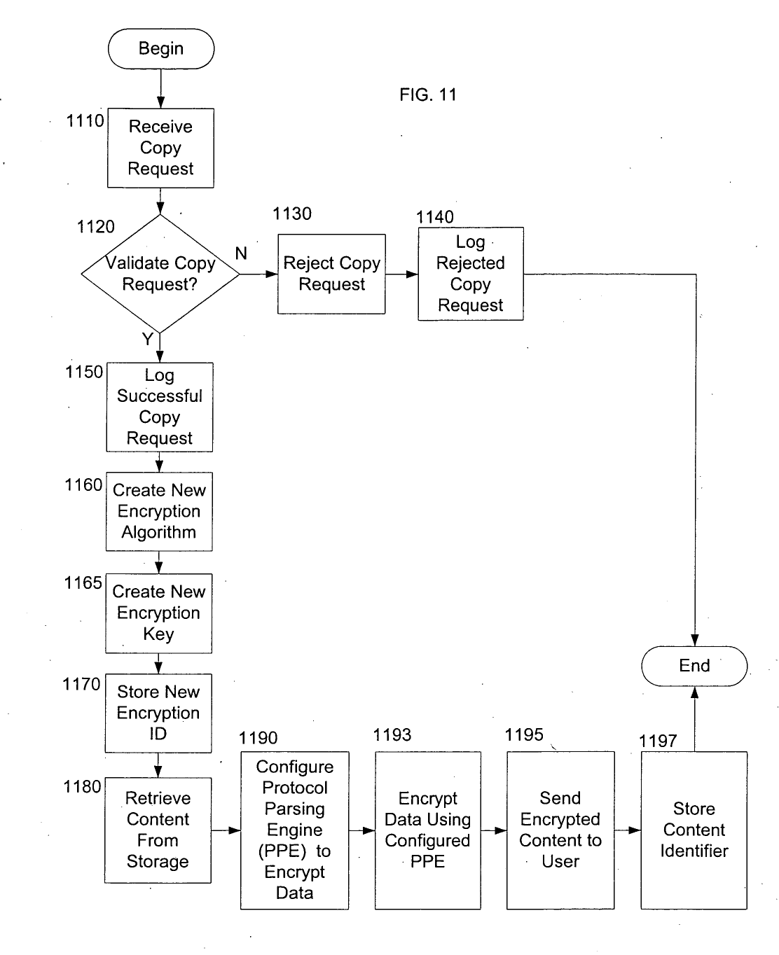

An alternative method of operating a content provider 10 to allow an encrypted content item to be copied by a content user 20 is shown in FIG. 11. This method performs the copying and encryption steps at the content provider 10 instead of at the content user 20. Security is thereby enhanced, at a tradeoff of increased network bandwidth usage, increased demand on the computer 12 at the content provider 10, and increased storage requirements for the data storage 14, since it must store a master copy of all content ever sold, not just a current catalog of content for sale.

The method begins at step 1110 when the content provider 10 receives a request to copy encrypted content from a content user 20, via the network 30 and communications link 16. The request processor 40 receives the copy request, and validates the request at step 1120. The request is validated by, for example, comparing an identifier provided by the content user 20 with the corresponding identifier created when the encrypted content was initially purchased by the content user 20. This corresponding identifier is stored at the content provider 10, as discussed at step 675 of FIG. 6. If there is a charge for copying previously purchased content, then a billing procedure similar to that discussed at steps 620-625 of FIG. 6 is followed as part of the validation step. If the content provider 10 cannot validate the copy request, then at step 1130, the copy request is rejected, and the rejection is conveyed back to the content user 20. At step 1140, the rejected request is sent to the logging module 42, for logging in the data storage 14. This allows the content provider 10 to keep track of the history of copy requests, should the content provider 10 wish to investigate possible fraud attempts or other such issues.

If the validation request is successful, then at step 11 50, the copy request, or the identifier in the copy request, is sent to the logging module 42 for logging in the data storage 14. Then at step 1160, in response to the validated copy request, the algorithm generator 43 generates a new encryption algorithm to be used to encrypt the copy, once it is made. The algorithm generator 43 performs this step in a manner similar to generating new encryption algorithms for newly purchased content, as discussed for step 630 of FIG. 6. Once the encryption algorithm is generated by the algorithm generator 43, then at step 1165 a key for the generated algorithm is created by the key generator 44. The key generation step proceeds similarly to that at step 635 of FIG. 6 above. Once the encryption algorithm and encryption key have been generated, then at step 1170 the logging module 42 stores a new encryption ID in the data storage 14 at the content provider 10 for the new copy. This step is performed in a manner similar to step 640 of FIG. 6 above.

At step 1180, the request processor 40 retrieves the content to be copied from the data storage 14, or from any other data storage where the content to be copied may be stored, and 10 hands the content off to the protocol parsing engine 47. At step 1190, the protocol parsing engine 47 receives a protocol description containing the encryption algorithm and encryption key generated above for the content to be copied, thereby configuring the protocol parsing engine 47 to encrypt input data according to the encryption algorithm and encryption key provided. Additionally, the protocol parsing engine 47 generates executable code modules for any operations specified in the protocol descriptions containing the algorithm and key generated above that have code generation routines specified for them. At step 1193, the content to be copied is provided to the protocol parsing engine 47 as input data, and the content to be copied is thereby encrypted. The protocol parsing engine 47 uses the executable code modules to streamline the encryption process. Once the content is encrypted, then at step 1195 the encrypted content is sent to the content user 20, along with an identifier identifying the encrypted content. This identifier may be the encryption ID discussed above, if that encryption ID cannot be reverse-engineered or otherwise inspected to extract the encryption algorithm or key. Alternatively the identifier may be some other sequence of data that identifies the specific copy of the content being sent to the content user 20. This identifier is also stored in the data storage 14 by the logging module 42, at step 1197.

Since the encryption algorithm and key are both generated on the fly and provided to the configurable protocol parsing engine 47, those skilled in the art will appreciate that the algorithm, the key, and the key length, as well as many other features and properties of the algorithm and key, can all be changed each and every time that a content user 20 makes a copy of content. This allows each copy of each content item copied by the content provider 10 to be encrypted not only with a unique key, but with a unique encryption algorithm, including algorithms with different key lengths.

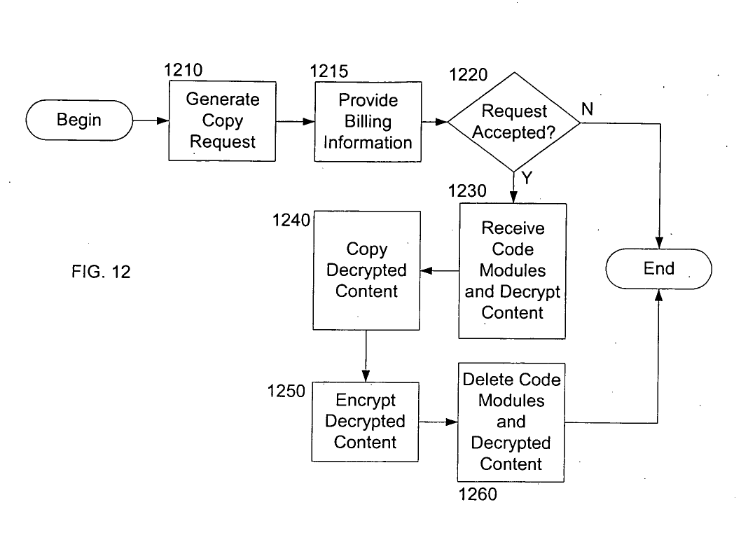

A method of operating a content user 20 to copy an encrypted content item 20 is shown in FIG. 12. The method begins at step 1210, where the request generator 51 at the content user 20 generates a request to copy content stored in encrypted form on the content user 20. Where the request generator 51 is a web browser, the content user 20 enters information such as the identifier associated with the encrypted content, which was previously provided to the content user 20 when the content user 20 purchased the content item. If there is a charge associated with copying the content item, then at step 1215 the content user 20 provides billing information, such as a credit card number, to the request generator 51. The request generator 51 then forwards all of this information on to the content provider 10, via the communications link 26 and on to the network 30.

At step 1220, the content user 20 receives a response back from the content provider 10. The request is either denied, if the content provider 10 was unable to validate the request (or process payment if any was required), or the request is accepted and an executable decryption code module and executable encryption code module are returned to the content user 20. Assuming that the executable decryption and encryption code modules are returned to the content user 20, the modules are provided to the security manager 52, at step 1230. In an embodiment, the executable decryption and encryption code modules are stored in volatile memory on the media reader 22 at the content user 20. Limiting the executable decryption and encryption code modules to volatile storage helps enhance the security of the system 5, since it is much more difficult for malicious content users 20 to obtain a copy of the executable decryption and encryption code modules, to possibly inspect or reverse-engineer them. The security manager 52 then retrieves the encrypted content item from the data storage 24, or other location where the encrypted content item is stored. The security manager 52 uses the encrypted content item as input data to the executable decryption code module, and creates a decrypted version of the content item. This decrypted version of the content item is also preferably stored in volatile storage, to minimize the potential for malicious content users 20 to obtain a copy of the decrypted content item. If the content item is too large to be easily stored in volatile memory, then the content item can be decrypted in pieces, each piece being stored in volatile memory until the piece is processed, and then the piece is erased and deleted and replaced with a successive piece of the decrypted content item.

Once the encrypted content item is decrypted, or as it is decrypted, the decrypted content item is copied by the media processor 53, at step 1240. The decrypted copy is also preferably stored in volatile memory, such as the RAM of the media reader 22, as discussed above. The decrypted copy is then provided as input to the executable encryption code module, at step 1250. This results in a newly encrypted copy of the content item being created, using the new algorithm and key contained in the executable encryption code module. Thus the original and the copy both remain on the content user 22, but they are both encrypted, using different algorithms and keys. The encrypted copy may now be freely distributed to another content user 20, or burned into a CD-ROM or DVD media disk, or the like, without fear that the content user 20 will be able to create further unencrypted copies. The second content user 20 may still play the copy of the content, by making his own play request to the content provider 10. At step 1260, the executable encryption and decryption code modules and the decrypted content are all erased and deleted from the memory they were stored in.

An alternative method of operating a content user 20 to obtain a copy of a content item is shown in FIG. 13. This method performs the copying and encryption steps at the content provider 10 instead of at the content user 20. Security is thereby enhanced, and processing resources at the content user 20 are conserved, at a tradeoff of increased network bandwidth usage, increased demand on the computer 12 at the content provider 10, and increased storage requirements for the data storage 14, since it must store a master copy of all content ever sold, not just a current catalog of content for sale. From the point of view of the content user 20, the method is treated identically to a purchase of new content, except that an identifier is sent to the content provider 10 to establish that the content user 20 is already in possession of a copy of the content item. This identifier may comprise information such as a small fragment of the encrypted content item, or any other information that uniquely identifies the copy of the content item possessed by the user. This information may be used by the content provider to, for example, make billing decisions (i.e. billing a content user 20 at a lower rate, or dispensing with billing entirely, for copies of content that the content user 20 already owns).

The method begins at step 1310, where the request generator 51 at the content user 20 generates a request to copy an identified content item. At step 1320 the content user 20 provides billing information if required by the content provider 10. The request generator 51 then forwards all of this information on to the content provider 10. At step 1330 the content user 20 receives the copied content, in encrypted form as discussed above, from the content provider 10. The encrypted content is stored in the data storage 24, at step 1340, where it is made available for future requests to play or copy the content.

It is possible that someone will make illicit copies of a content item encrypted using embodiments of the invention, and distribute those copies to other users. Each of these users may then make play requests, asking for permission to play their illicit copy. This illicit copying can be thwarted, however, by using the methods discussed above to change the algorithm and key associated with any content item, each time a play request is made. Effectively, this embodiment combines a copy request with every play request, creating true one-use copies of content items. With such a scheme, the first content user 20 to request to play any particular encrypted copy will be accepted, and his copy of the encrypted content will be re-encrypted after it is played. All successive content users 20, however, will be rejected, since either their identifiers will no longer match the identifier on file (which was changed when the first content user 20 made a play request), or alternatively the encrypted file will not be able to be unencrypted, since the decryption algorithm and key were changed by the first content user 20 when he made the first play request.

The use of the protocol descriptions discussed above, to encrypt and decrypt digital content, will now be discussed in more detail. The following simplified layout of Table 1 shows how a protocol structure/description could be defined by the user and organized in memory, in a manner consistent with the disclosures of U.S. Pat. No. 6,651,102, U.S. Pat. No. 6,493,761, U.S. Pat. No. 6,266,700, U.S. Pat. No. 6,000,041, U.S. Pat. No. 5,781,729, and U.S. Pat. No. 5,793,954, all of which have been incorporated herein by reference.

Basic cypher (encryption/decryption) operations can be described and implemented using one or more field descriptions declared in one or more protocol descriptions. A simplified layout of a protocol description is shown in Table 1 below and a field parsing algorithm for the protocol description of Table 1 is shown in Table 2 below. The algorithm of Table 2 is used to parse input data according to the protocol description of Table 1, to encrypt or decrypt data, as discussed above.

TABLE 1

```
Protocol 1
    Field1
        CypherType1
        CypherType2
        .
        .
        CypherTypeN
    Field2
    .
    .
    FieldN
Protocol 2
.
.
Protocol N
```

```
TABLE 2
For Each Field [FIndex] in Protocol [PIndex]
    If Any Cypher Operations Configured
        For Each Cypher [CIndex] Operation Configured for Field
        [FIndex]
            Perform Cypher [CIndex] on Field Contents
            Update Cypher [CIndex] using Loop Configuration
        End Each Cypher [CIndex] Operation Configured for Field
        [FIndex]
        If Required/Configured Update Protocol/Packet/Frame
        Checksum/CRC
    End Any Cypher Operations Configured
End For Each Field [FIndex] in Protocol [PIndex]
```

Each CypherType in Table 1 (Cypher [CIndex] in Table 2) represents one operation in an encryption or decryption algorithm. These operations are selected by the user wishing to implement an encryption algorithm, and chained together to implement the algorithm. A more detailed example of a data varying (e.g. encryption) algorithm is presented in the incorporated U.S. Pat. No. 6,651,102, at FIG. 7b.

Any number of CypherTypes can be chained together. This means the field parsing algorithm of Table 2, when used with for example, multiple CypherType operations, allows complex arithmetic operations to be applied to one or more fields within a protocol description. Similarly, this allows the user to configure and implement complex encryption/decryption algorithms that can be applied to a stream of data. The algorithm of Table 2 is executed zero or more times for each protocol description provided for the data being parsed. The algorithm loops through the field parsing loop zero or more times for each field in the protocol description. The algorithm performs all of the user-configured operations (such as the CypherType operations) on the field contents, as those user-configured operations were defined in the protocol description as discussed above. Once all of the user-configured operations defined for the field being parsed are performed, the algorithm processes the next field.

The protocol description contains several variables which allow the parameters of the features that describe the cypher to be changed. These variables are provided with default values, and routines (not shown) are created which allow the user to change the default values as desired. For example, the Sbox, Pbox, and Key sizes can be changed, the S and P boxes can be single or double indexed, the number of cyphering or decyphering loop iterations to perform on the data can be changed, the size of the data the operations are applied to can be changed, and obviously, the algorithm can be changed by configuring a different series of CypherType operations. Other alternatives, not shown, allow for use of different keys, S and P boxes, and algorithms for different parts (e.g. fields) of any media content (i.e. CD, DVD, mp3/wav file). Each field description in each protocol description may be setup with a chain of as many CypherType operations as desired to implement the desired encryption/decryption algorithm.

The code generation routines will now be discussed in more detail. Any of the protocol parsing operations described above or in the US patents incorporated by reference above can be specified in a protocol description, and can then have code generated which implements the operations. This code generation is performed by a collection of code generation routines that are associated with each user-defined operation (e.g. protocol, field, vary, filter, cypher, etc.). To generate code, each operation in the protocol description is replaced by a call to a routine that generates code that implements the operation. The code generation portion of the protocol parsing routine could be executed, for example, during the setup phase of configuration of the protocol parsing engine 47, (such as at step 105 of FIG. 9 of U.S. Pat. No. 6,651,102). Alternatively, the protocol parsing engine 47 could have a separate mode for code generation. Once generated, this code is then executed by a processor, to parse a stream of input data and perform the algorithm on the input data. Alternatively, by declaring a different set of code generation routines that operates on registers, instead of memory locations, it is possible to export the ability to program in assembly language all the way out to the user, thereby allowing the user to generate machine code directly, so that it is ready to be executed without needing to be assembled first. This is useful for implementations where speed/performance is critical.

It is possible to produce code (programming instructions) for virtually any processor or other programmable device. For instance, assuming the target processor architecture is known, the code generation routines could output machine code directly, so that it is ready to be executed on the target processor without needing to be assembled first. Alternatively, the code generation routines could output assembly code, or high-level programming language code, such as C or C++ code. Additionally, the code generation routines can produce programming instructions/configuration information suitable for the content addressable memory (CAM) typically used to perform rudimentary frame filtering in many network switches and routers.

The code generated can be optimized, and memory accesses performed by the processor executing the code can be minimized, by making assumptions and pre-assigning both meanings and values to registers that will apply to all generated code. For example, meanings and values can be pre-assigned as follows, for a particular target processor architecture:

1. a specific register will always contain a pointer to the start of the protocol header currently being parsed (i.e. code being generated for); therefore the register will contain ParsePtr as that term is used in U.S. Pat. No. 6,651,102 and the other US Patents incorporated by reference herein.

2. 64-bit values returned from any operation will be contained in two specific registers, where one register contains the upper 32 bits and the other contains the lower 32 bits.

3. 32-bit values returned from any operation will be contained in the first of the specific registers used for 64-bit values above, and the contents of the second specific register are undefined.

A code generation routine may use other data from the protocol description configured by the user, to select which of a plurality of code blocks to include in the generated code to perform the desired operation. Thus the code generation routine is configurable by the user, to adapt to changes in the structure of the data being parsed, for example to accommodate variable-length fields in the data being parsed, or to accommodate differences in the code needed to perform a particular operation, depending on factors such as the size of the input data, or the location of the input data within a data packet or stream, or other factors.

For example, the code generation routine may include a plurality of code blocks each designed to extract different length values from a field within a data stream, such as an 8-bit value, a 16-bit value, etc. These values may be extracted from different points in the field, based on an offset from the beginning of the field. For example, one of the code blocks may specify that an 8-bit value will be extracted from within a 64-bit field, beginning at bit 8. Another code block within the same code generation routine may specify that a 16-bit value will be extracted from a 64-bit field, beginning at bit 12. The code generation routine will read a data value (i.e. an extracted-value length, or a field length) from the protocol description provided by the user, and use this data value to decide which code block to generate (i.e. if the extracted value length=8, then generate a code block for extracting an 8-bit value; if the field length=64, then generate a code block for extracting a value from a 64-bit field) The generated code may also contain more complex data-dependant code blocks, such as: if the extracted value length=8 and the field length=64 and the offset=12, then generate a code block for extracting an 8-bit value from a 64-bit field, beginning at bit 12.

As a second example, a code generation routine generates code that adds the value extracted from a field to a global variable. This add routine, when implemented in assembly language, uses two ADD assembly commands if the field is greater than 32 bits long, but only one if the field length is<=32 bits. Thus the routine generates code to skip the second ADD if the field is<=32 bits long (i.e. there is no carry bit after the first ADD). The routine will determine the length of the field by extracting this information as it was specified by the user elsewhere in the protocol description. This is an advantage because one ADD command is faster than two ADD commands. Especially since the first ADD command can be paired with a JNC command and executed in one processor clock cycle.

To discuss a particular example of code generation in more detail, Table 3 below depicts the steps to be used in an example of data filtering.

TABLE 3
Input Data for Code Generation Routines for Filtering Function, Table Form

| | | | Nxt | | | Even/ | Curr | |
|---|---|---|---|---|---|---|---|---|
| | Criteria | Range | Criteria | Min | Max | Odd/All | Protocol | Curr Field |
| Channel Idx | Idx | Idx | Idx | Value | Value | Bits | Ptr | Ptr |
| // Example 1 | | | | | | | | |
| (Channel 0) | | | | | | | | |
| 0 | 0 | 0 | 1 | 0x800 | 0x800 | All | ETHERII | type |
| 0 | 1 | 0 | 2 | 0x6 | 0x6 | All | IP_V4 | Protocol |
| 0 | 2 | 0 | 3 | 0x17 | 0x17 | All | TCP | SourcePort |

The example specifies filter criteria that select input data frames which match the following filter specification:

(ETHERII→type==0×800 &&

IP_V4→Protocol==0×6 &&

TCP→SourcePort==0×17)

The filtering code generation routine created by the developer parses the protocol description above, provided by the user, and identifies the first filter channel to be processed.

The code generation routine generates code that extracts the value stored in the ETHERII→type field of the input data to be filtered, and compares the ETHERII→type field value with the criteria value of 0×800. The code generation routine then generates code that extracts the value stored in the IP_V4→Protocol field and compares that value with the criteria value of 0×6. The code generation routine then generates code that extracts the value stored in the TCP→SourcePort field and compares that value with the criteria value of 0×17. In addition to generating the specific filter criteria matching code based on the filter criteria specified by the user, the code generation routine also generates supporting code, such as code to output the results (match/no match) of the filtering, or code to handle special situations with the input data.

For example, one of the advantages of using the protocol description to generate filtering code is in handling a special case with the IP_V4 protocol header. The length of the IP_V4 protocol header is variable (20 bytes are always there and up to 40 bytes of options may be added in 4 byte increments). This means that there are 11 possible header sizes (20, 24, 28, . . . 60), and thus 11 possible different locations for the filtering algorithm to have to go to extract the values stored in the protocols which follow the IP_V4 protocol (such as the TCP protocol in the above example). The generated code automatically accounts for this possibility by extracting the actual header length from the IP_V4 header contained in the input data, and adding it as an offset to all subsequent filtering checks. Thus, the generated code can accurately determine the proper location to read the TCP protocol data from within the input data. Alternatively, the code generation routines discussed above can be altered to issue commands to automatically program content addressable memories (CAMs) with the required values and masks after the filter has been configured by specifying protocols, fields, and (un)acceptable ranges(criteria) of values. This is intuitively more obvious and easier for a typical user to use. Other special situations can be anticipated by the developer and code generation routines can be written which take them into account.

This data filtering function is a further example of the sort of functions that code can be generated for, according to an embodiment of the invention. Data filtering is one of the functions frequently performed by protocol analyzers, such as the configurable protocol analyzers discussed in the incorporated US Patent references mentioned above. Those skilled in the art will appreciate that all of the functions of a protocol analyzer may be implemented in code generation routines of an embodiment of the invention. Thus, an entire protocol analyzer, specially configured to suit a particular design, may be created by supplying a user-configured protocol description as an input to a protocol parsing engine, which will generate the executable code that implements the protocol analyzer.

By adding routines to generate code for every operation that could possibly be performed by a protocol parsing engine, it would possible to, for example, generate code that could first filter network frames, then parse frames containing any configured protocols and fields while also generating code for gathering statistics, verifying checksums and CRCs, varying field values, encrypting or decrypting the data, recomputing checksums and CRCs, and performing routing (route table lookups). Also, by adding additional code generation support routines it would be possible to create a system that could generate code that implements an entire protocol or even an entire switch and/or router, all from user configured protocols, fields, filters, lookups, varies, checksums, CRCs, statistics, and route tables.

Typically, switches/routers have two paths through the hardware/software. A “fast path” for operations that are performed often, and a slower “normal path” for operations that are performed infrequently and are not time critical. Using the principles discussed above, a system/application that could generate code to implement the “fast path” code can be produced. This would allow the switch/router owner to configure, tailor or reprogram the “fast path” protocols and features supported, in the field.

In the foregoing specification, the invention has been described with reference to specific embodiments thereof. It will, however, be evident that various modifications and changes may be made thereto without departing from the broader spirit and scope of the invention. For example, the content protection system could be used to protect content other than digital content, such as analog content; or the code generation routines could be used to generate other types of code, such as source code, machine language, or even English or other human-readable language code or documentation. The specification and drawings are, accordingly, to be regarded in an illustrative rather than restrictive sense, and the invention is not to be restricted or limited except in accordance with the following claims and their legal equivalents.

We claim:

1. A method of securely distributing digital content, comprising:
receiving a content distribution request from a content user;
retrieving a digital content item in response to the content distribution request;
receiving a protocol description comprising a first encryption algorithm for encrypting the digital content item;
configuring a protocol parsing engine to encrypt the digital content item, using protocol descriptions;
encrypting the digital content item using the configured protocol parsing engine; and
transmitting the encrypted digital content item to the content user.

2. The method of claim 1, further comprising receiving a first encryption key.

3. The method of claim 2, wherein the configuring step further comprises using the first encryption key.

4. The method of claim 1, wherein the configuring step comprises configuring the protocol parsing engine to generate computer code that when executed encrypts the digital content item.

5. The method of claim 1, further comprising recording an encryption identifier adapted to identify the first encryption algorithm.

6. The method of claim 1, wherein at least one property of the first encryption algorithm is different from a corresponding property of a second encryption algorithm, the second encryption algorithm being used to encrypt a second digital content item transmitted.

7. The method of claim 1, wherein receiving the encryption algorithm comprises retrieving the encryption algorithm from a pool of encryption algorithms.

8. The method of claim 1, wherein receiving the encryption algorithm comprises receiving from a user the protocol description comprising the encryption algorithm.

9. The method of claim 1, further comprising processing payment information about the content distribution request.

10. The method of claim 1, wherein the encryption algorithm comprises a plurality of cypher operations in a protocol description.

11. The method of claim 1, wherein the content distribution request comprises a request to purchase the digital content item.

12. The method of claim 1, wherein the content distribution request comprises a request to copy the digital content item.

13. A method of securely accessing encrypted digital content, comprising:
requesting from a content provider access to encrypted digital content;
receiving decryption information from the content provider;
decrypting the encrypted digital content using the decryption information;
accessing the decrypted digital content; and
deleting the decryption information.

14. The method of claim 13, further comprising erasing the decryption information.

15. The method of claim 13, wherein the encrypted digital content is stored locally.

16. The method of claim 13, wherein the decryption information comprises an executable decryption code module.

17. The method of claim 16, wherein the executable decryption code module is created on demand by the content provider.

18. The method of claim 16, wherein the executable decryption code module is created using a protocol parsing engine configured with protocol descriptions to generate executable code.

19. The method of claim 18, wherein the executable decryption code module is created using one or more protocol descriptions each comprising one or more field descriptions each comprising one or more cypher operations.

20. The method of claim 13, wherein the received decryption information is stored in volatile memory.

21. The method of claim 13, wherein the decrypted digital content is stored in volatile memory.

22. The method of claim 13, further comprising deleting the decrypted digital content once it has been accessed.

23. The method of claim 22, further comprising erasing the decrypted digital content once it has been accessed.

24. The method of claim 13, further comprising receiving encryption information from the content provider and re-encrypting the decrypted digital content, using the encryption information.

25. The method of claim 24, wherein the encryption information is different from second encryption information used to initially encrypt the decrypted digital content.

26. The method of claim 13, wherein accessing comprises playing the digital content.

27. The method of claim 13, wherein accessing comprises displaying the digital content.

28. The method of claim 13, wherein accessing comprises copying the digital content.

29. A method of providing secure access by a content user to encrypted digital content, comprising:
receiving a request to access encrypted digital content;
receiving a protocol description comprising a decryption algorithm for decrypting the encrypted digital content;
configuring a protocol parsing engine to generate a code module for decrypting the encrypted digital content according to the decryption algorithm, using protocol descriptions;
generating the code module for decrypting the encrypted digital content, using the protocol parsing engine;
transmitting the code module to the content user.

30. The method of claim 29, wherein the code module comprises an executable code module.

31. The method of claim 29, wherein receiving a protocol description comprises retrieving a stored protocol description from a data storage.

32. The method of claim 29, wherein receiving a protocol description comprises accepting a newly defined protocol description from a user.

33. The method of claim 29, wherein the request to access encrypted digital content comprises an identifier identifying the digital content.

34. The method of claim 33, wherein retrieving the decryption algorithm comprises regenerating a decryption algorithm, based on the identifier.

35. The method of claim 29, further comprising:
receiving a second protocol description comprising an encryption algorithm for re-encrypting the encrypted digital content once the encrypted digital content has been decrypted;
configuring the protocol parsing engine to generate a second code module for re-encrypting the encrypted digital content once the encrypted digital content has been decrypted, using the second protocol description;
generating the second code module using the protocol parsing engine; and
transmitting the second code module to the content user.

36. The method of claim 35, wherein receiving a second protocol description comprises retrieving a stored protocol description from a data storage.

37. The method of claim 35, wherein receiving a second protocol description comprises accepting a newly defined protocol description from a user.

38. The method of claim 35, wherein at least one property of the encryption algorithm for re-encrypting the encrypted digital content is different from a corresponding property of an encryption algorithm used to initially encrypt the encrypted digital content.

39. The method of claim 29, wherein the request to access comprises a request to play the encrypted digital content.

40. The method of claim 29, wherein the request to access comprises a request to copy the encrypted digital content.

41. A secure digital content distribution system, comprising:
a computer; and
a data storage;
wherein the computer comprises:
a protocol parsing engine;
a request processor; and
an algorithm generator.

42. The secure digital content distribution system of claim 41, wherein the protocol parsing engine comprises common control logic.

43. The secure digital content distribution system of claim 41, wherein the algorithm comprises an encryption algorithm.

44. The secure digital content distribution system of claim 43, wherein the encryption algorithm is selected from a plurality of encryption algorithms available to the computer.

45. The secure digital content distribution system of claim 41, wherein the protocol parsing engine is adapted to generate code when configured with a protocol description comprising a specification of a code generation routine.

46. The secure digital content distribution system of claim 45, wherein the code comprises executable code.

47. The secure digital content distribution system of claim 46, wherein the code comprises executable decryption code.

48. The secure digital content distribution system of claim 46, wherein the code comprises executable encryption code.

49. A method for generating computer code according to configurable criteria, comprising:
storing a programmably configurable protocol description, the programmably configurable protocol description containing a protocol control record and at least one field sub-record for specifying at least one configured operation for which a code generation routine is implemented;
storing a program for controlling a code generation routine to be executed by a processing unit, the program including instructions for causing the processing unit to retrieve the programmably configurable protocol description and to vary the execution of the code generation routine based upon the retrieved protocol description;
delivering to the processing unit the program for controlling the code generation routine; and
causing the processing unit to execute the code generation routine, thereby generating computer code.

50. The method of claim 49, wherein the computer code comprises executable code.

51. The method of claim 49, wherein the computer code comprises source code.

52. A machine implemented process for generating computer code according to programmably configurable criteria, the process comprising the steps of:
storing at least one programmably configurable protocol description in a data storage device, the at least one programmably configurable protocol description comprising a protocol control record and at least one field sub-record for specifying at least one configured operation for which a code generation routine is implemented;
retrieving the at least one protocol description from the data storage device; and
providing the at least one protocol description to a common control logic module configured such that upon receiving the at least one protocol description, the common control logic module generates code based upon the code generation routine implemented for the configured operation specified in the protocol description.

53. The process of claim 52, wherein a plurality of programmably configurable protocol descriptions are stored in the data storage device, and wherein the programmably configurable protocol descriptions are selectively retrieved from the data storage device in response to selected input data sequences.

54. A method of generating code comprising:
providing a common control logic module;
providing to the common control logic module a protocol description including a description of a code generation routine;
generating code in response to the provision of the protocol description, using the code generation routine; and
outputting the generated code.

55. The method of claim 54, wherein the generated code comprises executable code.

56. The method of claim 54, wherein the generated code comprises source code.

57. The method of claim 54, wherein the protocol description comprises a specification of a plurality of code generation routines, each code generation routine adapted to generate code to perform a protocol parsing function.

58. The method of claim 54, wherein the protocol description comprises a protocol record and a field record associated with the protocol record, and the field record describes the code generation routine.

59. The method of claim 58, wherein the field record comprises a plurality of cypher operations.

60. The method of claim 58, wherein the field record comprises a plurality of filter operations.

61. The method of claim 54, wherein the generated code is outputted to the common control logic module, to facilitate further data processing by the common control logic module.

62. The method of claim 59, wherein facilitating further data processing comprises encrypting or decrypting input data provided to the common control logic module.

63. A computer program product that includes a medium useable by a processor, the medium having stored thereon a sequence of instructions which, when executed by said processor, causes said processor to execute a method of generating code comprising:
providing a common control logic module;
providing to the common control logic module a protocol description including a description of a code generation routine;
generating code in response to the provision of the protocol description, using the code generation routine; and
outputting the generated code.

64. The computer program product of claim 63, wherein the protocol description comprises a protocol record and a field record associated with the protocol record, and the field record describes the code generation routine.

65. The computer program product of claim 64, wherein the field record comprises a plurality of cypher operations.

66. The computer program product of claim 64, wherein the field record comprises a plurality of filter operations.

67. The computer program product of claim 63, wherein the generated code comprises executable code.

68. The computer program product of claim 63, wherein the generated code comprises source code.

69. The computer program product of claim 63, wherein the protocol description comprises a specification of a plurality of code generation routines, each code generation routine adapted to generate code to perform a protocol parsing function.

70. The computer program product of claim 63, wherein the generated code is outputted to the common control logic module, to facilitate further data processing by the common control logic module.

71. The computer program product of claim 70, wherein facilitating further data processing comprises encrypting or decrypting input data provided to the common control logic module.

72. A system for generating computer code, comprising:
a common control logic module adapted to:
receive a first protocol description including a specification of a code generation routine;
generate computer code using the specified code generation routine; and
output the generated computer code; and
a storage device adapted to store a plurality of protocol descriptions including the first protocol description, and provide the first protocol description to the common control logic module.

73. The system of claim 72, wherein the protocol description comprises a protocol control record and at least one field sub-record for specifying a configured operation for which the code generation routine is implemented.

74. A method of generating computer code, comprising:
providing a plurality of code generation routines, each code generation routine adapted to generate computer code to perform a defined function;
providing a protocol description comprising a plurality of calls to one or more of the plurality of code generation routines;
providing the protocol description to a protocol parsing engine; and
causing the protocol parsing engine to generate computer code using the protocol description.

75. The method of claim 74, wherein the plurality of calls implements an algorithm.

76. The method of claim 75, wherein providing a protocol description further comprises creating the protocol description by selectively creating the plurality of calls, to implement the algorithm.

77. The method of claim 75, wherein the algorithm comprises an encryption or decryption algorithm.

78. The method of claim 75, wherein the algorithm comprises a protocol parsing algorithm.

79. The method of claim 75, wherein the algorithm comprises a data filtering algorithm.
